(19) United States
(12) Patent Application Publication
(10) Pub. No.: US 2003/0184709 A1
(43) Pub. Date: Oct. 2, 2003

(54) Hinge for spectacles

(75) Inventor: Giovanni Sommavilla, Calalzo Di Cadore (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: SOM OCCHIALI SRL

(21) Appl. No.: 10/401,450

(22) Filed: Mar. 28, 2003

(30) Foreign Application Priority Data
Mar. 29, 2002 (IT) UD2002U000023

(51) Int. Cl. G02C 1/00; G02C 5/22

(52) U.S. Cl. 351/153; 351/89; 351/41

(57) ABSTRACT

Hinge for spectacles (11), able to connect a frame (14) for lenses (17) to a relative arm or temple (12), comprising pivoting means consisting of bushing means (15a, 15b) solid with a lateral part (13) of said frame (14) and of a mating pin (16), solid with said arm (12). The pin (16) is inserted with interference inside the bushing means (15a, 15b) and is able to rotate with respect thereto. The bushing means comprises a first lower bushing (15a) and a second upper bushing (15b) facing each other, the gap (“d”) between the bushing (15a, 15b) defining a slot where the terminal part of the arm (12) connected to the relative pin (16) can rotate.

### FIELD OF THE INVENTION

The present invention concerns a hinge for spectacles used to connect an arm or temple to the lateral part of the frame which supports the lenses, also called the endpiece.

The invention is advantageously used in spectacles with arms and frame made of metal, although the invention can also be applied to spectacles of other types.

### BACKGROUND OF THE INVENTION

In the field of spectacles the state of the art includes various types of hinges used to connect the arm and the endpiece, that is, the lateral part of the frame which supports the lenses Such hinges normally have two parts, one associated with the endpiece and one with the arm, coupled to each other in rotary fashion by means of screw means, or similar, generally of extremely limited size.

Some hinges also have elastic means which facilitate the movement of the arms in the open, closed and maximum opening positions.

Since the cost of such hinges significantly affects the overall cost of the spectacles, producers in this field have looked for simpler solutions which allow to contain said costs, yet without obtaining satisfactory results. In fact, in almost all the solutions proposed, the presence of extremely small screws does not allow a concrete reduction in costs, particularly those deriving from the assembly times, because specific tools and extremely precise operations are required.

In other, more economical realizations, the disadvantage is that the hinge is not very efficacious and reliable so that, after even a limited use, it can lose its functionality or in certain cases it can break.

EP-A-926.530, on which is based the preamble of the independent claim, discloses a lens-to temple joint comprising a ring-like piece solid with the frame of the lenses and a hammer head-like projection solid with the temple. The ring-like piece has a vertical slot to allow the fitting of the hammer projection inside it and an horizontal slot which allows to the hammer, and thus to the temple, to rotate between two limit positions. EP'530 also discloses the provision of an annular bush between the ring-like piece and the hammer projection to increase the friction against the rotation of the temple.

A first shortcoming of this solution is the complexity of the working made on the ring-like piece or on the bush to provide the shaped horizontal and vertical slots.

Another shortcoming is the through hole of the ring piece which causes to the hammer projection to get out from its seating if the temple, for example in a non-use situation, is carried in correspondence of the vertical slot. A further shortcoming is the fact that the terminal part of the temple slides on the edges of the horizontal slot and may readily degrade.

The present Applicant has devised and embodied this invention to overcome the shortcomings of the state of the art and to obtain other advantages.

### SUMMARY OF THE INVENTION

The invention is set forth and characterized essentially in the main claim, while the dependent claims describe other innovative characteristics of the invention.

The purpose of the invention is to achieve a hinge for spectacles which is simple, economical and which allows the arms to be associated with the frame of the spectacles easily and quickly.

Another purpose is to achieve a hinge for spectacles which is strong and resistant to the stresses and strains to which it is subjected during use.

In accordance with said purposes, the hinge for spectacles according to the invention comprises pivoting means consisting of bushing means, solid with the frame, and of a mating pin, solid with one arm, inserted inside the bushing means, coupled due to its mating shape, and rotary with respect thereto.

Each bushing means is axially provided with a hole having a diameter mating with the diameter of the pin and inside which the latter is able to be inserted, with the desired interference, for at least a segment, thus achieving said coupling by mating shape.

According to the invention, the bushing means comprise two equal bushings, a first upper and a second lower, having the respective holes facing each other and mounted at a distance which allows to an arm or temple solid with the pin to rotate between the closed and open positions.

In a preferential embodiment, the bushing means and the pin are attached respectively to the frame and the arm by means of welding and, in an even more preferential embodiment, by means of ultrasound welding.

When the hinge is in its assembled condition, the pin is axially clamped between the bushing means but is rotatably unconstrained so as to allow the arm to which it is attached to move, without being able to come free.

According to a characteristic feature of the invention, the holes of the bushing means have the lateral surface provided with means to increase the interference with the pin, by means of which a desired resistance is achieved against the rotation of the latter and hence of the relative arm; in this way possible involuntary rotations of the arm are prevented and the open and closed positions are made more stable.

In a preferential embodiment, the means to increase interference consist of knurls or similar workings. According to a variant, the means to increase interference consist of micro-ridges or similar elements.

The hinge according to the invention is assembled by first attaching a first bushing means to the frame and the pin to the relative arm; one end of the pin is then inserted into the hole, for example a dead hole, of the first bushing means; the second bushing means is coupled with the second end and finally is also welded to the frame.

Thanks to the limited number of components and the ease and speed of assembly, the hinge for spectacles according to the invention is extremely simple and economical both in production and in application, allowing a significant reduction in the overall cost of the spectacles on which it is used.

The bushing means are simple little holed cylinders and do not require any further working. The distance or gap between the bushing means can set at a value slightly greater than the thickness of the terminal part of the arm so to avoid any risk of damaging contact between the arm and the edges of the bushing means.

When the bushing means are mounted, the pin can not in any way get out form its seating.

### BRIEF DESCRIPTION OF THE DRAWINGS

These and other characteristics of the present invention will be apparent from the following description of a preferential form of embodiment, given as a non-restrictive example, with reference to the attached drawings wherein:

FIG. 1 is a front view of a pair of spectacles using hinges according to the present invention;

FIG. 2 partly shows the view from above of FIG. 1;

FIG. 3 partly shows the side view of FIG. 1;

FIG. 4 shows an enlarged detail of FIG. 3;

FIG. 5 is a view from above of FIG. 4;

FIG. 6 shows the components of the hinge according to the present invention;

FIGS. 7a-7c show schematically the stages of assembling the hinge according to the invention.

### DETAILED DESCRIPTION OF A PREFERENTIAL EMBODIMENT

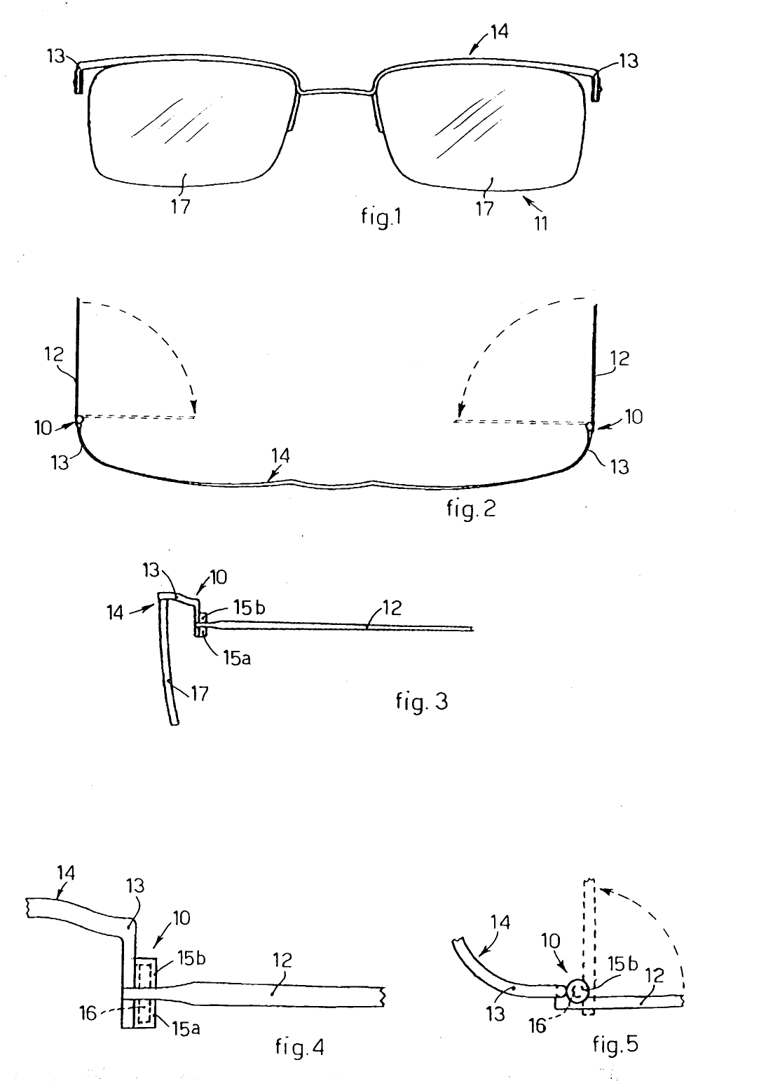

With reference to the attached drawings, the number 10 denotes generally the hinge for spectacles 11 according to the present invention, used to associate, and allow the rotation of, each arm 12 to the endpiece 13 of the frame 14 supporting the lenses 17 (FIGS. 1 and 2).

In this case, the spectacles 11 have a frame 14 and arms 12 made with thin metal profiles, but this does not constitute a limit to the application of the invention, which can also be used for spectacles 11 of other types, and can also be made of different material.

The hinge 10 comprises three components which can be axially coupled together: two bushings, upper 15a and lower 15b, solid or made solid with the endpiece 13 and a pin 16 solid or made solid with the arm 12.

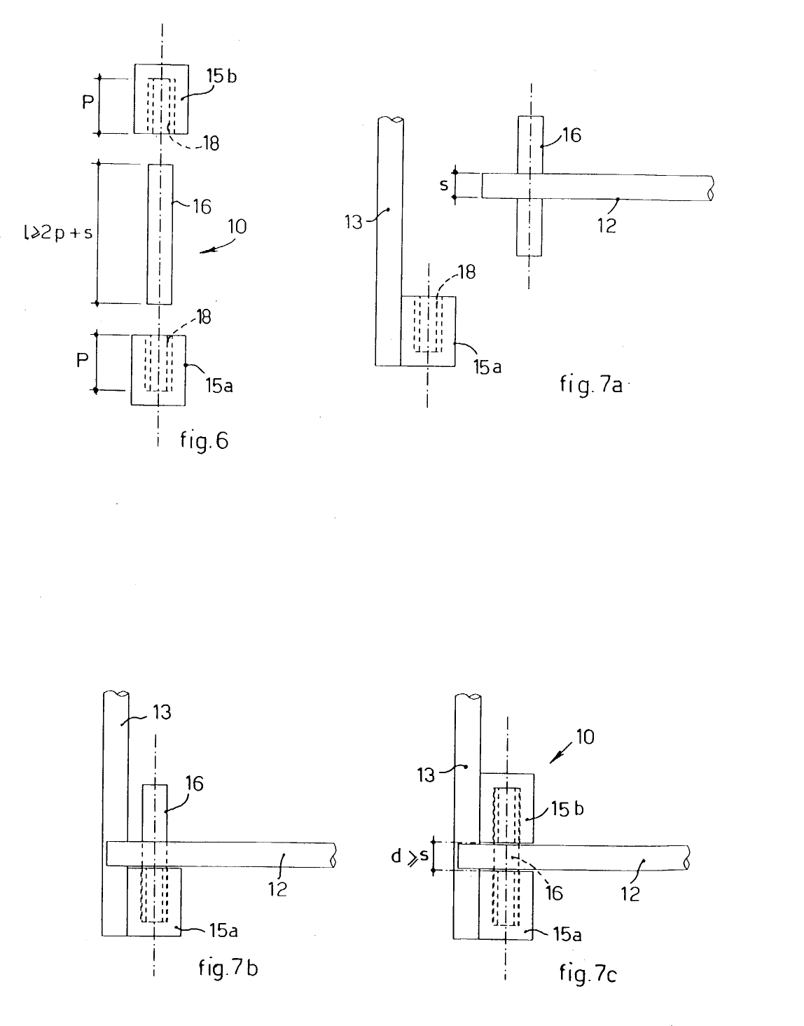

The bushings 15a and 15b axially include respective dead holes 18, the apertures of which are arranged, during use, one facing the other (FIG. 6).

The dead holes 18 have a diameter equal to, or only slightly more than, that of the pin 16 which, when the hinge is assembled, can be partly inserted inside them with a desired interference.

To be more exact, the pin 16 has a length “l” equal to or greater than the sum of the depths “p” of the dead holes 18 and the thickness “s” of the arm 12 at the point where it is attached to the pin 16: in fact, 1>2 p+s.

In this way, when the hinge 10 is in its assembled condition, that is, with the pin 16 inserted into the two dead holes 18 until it touches the end, the gap “d” between the two bushings 15a and 15b is equal to or more than the thickness “s” of the arm 12.

The end of the arm 12 associated with the pin 16 advantageously has a flattened section to facilitate coupling with the ends of the bushings 15a, 15b. The dead holes 18 also have the lateral surface knurled, to create a desired interference with the lateral surface of the pin 16 and hence a determinate resistance to the rotation thereof, as will be explained hereafter.

According to a variant of the invention, the lateral surface of the dead holes 18, instead of knurls, has other means to accentuate interference, such as for example ridged elements or similar.

With reference to FIGS. 7a-7c the following description refers to the assembly of the hinge 10 with which the arm 12 is connected to the endpiece 13 of the frame 14.

Firstly, the lower bushing 15a is attached to the endpiece 13 with the aperture of the dead hole 18 facing upwards and the pin 16 is attached at its median point to the arm 12 (FIG. 7a). It is clear that one of the two bushings 15a or 15b and the pin 16 can also be made directly in a single piece respectively with the frame 13 and the arm 12.

Then, the pin 16 is inserted into the dead hole 18 of the lower bushing 15a, until it touches the bottom (FIG. 7b), and the upper bushing 15b is inserted from above onto the pin 16. Finally, to complete the assembly, the upper bushing 15b is also attached to the endpiece 13.

The bushings 15a and 15b and the pin 16 are advantageously attached by welding, for example by ultrasound; however, it comes within the field of the invention to use other attachment techniques, which are chosen according to the material of which the frame 14 and arms 12 of the spectacles 11 are made.

When the hinge 10 is in its assembled condition, the pin 16 is axially clamped between the two bushings 15a and 15b which therefore prevent it from coming free, but allow it to rotate in order to move the relative arm 12. The presence of the knurled lateral surface of the dead holes 18, however, determines a desired resistance to the rotation of the pin 16 and hence of the arm 12; this prevents the involuntary rotation of the arm 12, but allows it to be moved manually, thus encouraging the stability of the positions assumed.

Modifications and/or additions of parts may be made to the hinge 10 for spectacles as described heretofore, without departing from the field and scope of the present invention.

1. Hinge for spectacles (11), able to connect a frame (14) for lenses (17) to a relative arm or temple (12), comprising pivoting means consisting of bushing means (15a, 15b) solid with a lateral part (13) of said frame (14) and of a mating pin (16), solid with said arm (12), said pin (16) being inserted with interference inside said bushing means (15a, 15b) and being able to rotate with respect thereto, characterised in that said bushing means comprises a first lower bushing (15a) and a second upper bushing (15b) facing each other, the gap (“d”) between said bushing (15a, 15b) defining a slot where the terminal part of the arm (12) connected to the relative pin (16) can rotate.

2. Hinge as in claim 1, characterised in that each of said bushing means (15a, 15b) comprises a hole (18) with a diameter mating to the diameter of said pin (16) and inside which a respective part of the pin (16) is able to be inserted for a defined segment.

3. Hinge as in claim 2, characterised in that said hole (18) is dead.

4. Hinge as in claim 2 or 3, characterised in that said pin (16) is inserted into said dead hole (18) of at least said lower bushing (15a) until it touches the bottom.

5. Hinge as in any claim hereinbefore, characterised in that said hole (18), at least on its lateral surface, has means to increase the interference with said pin (16), able to determine a resistance to the rotation thereof.

6. Hinge as in claim 5, characterised in that said means to increase the interference consist of knurls or similar workings.

7. Hinge as in claim 5, characterised in that said means to increase the interference consist of ridges or similar elements.

8. Hinge as in any claim hereinbefore, characterised in that, in correspondence with the zone wherein it is associated with the pin (16), said arm (12) has a flattened section.

9. Hinge as in any claim hereinbefore, characterized in that said bushing means (15a, 15b) and said pin (16) are able to be attached respectively to said frame (14) and to said arm (12) by means of welding.
